(19) United States
(12) Patent Application Publication
(10) Pub. No.: US 2009/0044828 A1
(43) Pub. Date: Feb. 19, 2009

(54) Methods and Systems for Debonding an Undesirable Material from a Device Using Ultrasonic Energy and Liquid Nitrogen

(76) Inventors: Sudhir R. Brahmbhatt, Glencoe, MO (US); Richard R. Masi, Perkiomenville, PA (US)

Correspondence Address: AIR LIQUIDE;Intellectual Property, 2700 POST OAK BOULEVARD, SUITE 1800, HOUSTON, TX, 77056, US

(21) Appl. No.: 11/839,153

(22) Filed: Aug. 15, 2007

(51) Int. Cl. B08B 3/12

(52) U.S. Cl. 134/1; 134/115 R

(57) ABSTRACT

An undesirable material is at least partially debonded from a surface of a device at least partially immersed in a vessel containing subcooled liquid nitrogen by applying ultrasound energy with a sonicating member to the device via the subcooled liquid nitrogen.

### CROSS-REFERENCE TO RELATED APPLICATIONS

This application is related to U.S. patent application Ser. No. 11/839,100, filed concurrently herewith entitled, “METHODS AND SYSTEMS FOR SANITIZING OR STERILIZING A MEDICAL DEVICE USING ULTRASONIC ENERGY AND LIQUID NITROGEN”.

### BACKGROUND

The selection of the proper method for removal of an undesirable material from a device, such as paint from metal surfaces of hangers used in painting is always a concern. This is because many of those methods are not simple or economical. Some key methods include the following.

Cryogenic shot-blast technology involves dipping hangers or metal into liquid nitrogen followed by shot blasting the brittle paint or plastic material to clean the metal surface. This technology is relatively capital intensive and has a primarily mechanical mechanism for cleaning.

Burning technology involves direct or indirect heating to burn off paint on hangers, but it often leads to thick black smoke and highly polluted exhaust that needs proper clean up in order to meet applicable EPA requirements. Also, high energy costs can undesirably increase the method's operating costs.

Chemical cleaning involves the use of solvents to dissolve paint, but the storage of solvent and disposal of spent solvent are subject to many environmental regulations.

Application of a non-solvent chemical to hangers requires the use of chemicals that may be health hazards. It does not find popular use in the hanger cleaning industry.

Some have proposed solutions to these problems, including the disclosures of U.S. Pat. No. 5,284,625, U.S. Pat. No. 5,258,413, U.S. Pat. No. 6,343,609, and U.S. Pat. No. 5,456,759.

### SUMMARY

There is disclosed a method of debonding an undesirable material from a device, including the following steps. A vessel containing liquid nitrogen provided. A device having a surface with an undesirable material bonded thereto is provided. At least a portion of the bonded material and surface is immersed in the liquid nitrogen within the vessel. Ultrasonic wave energy is caused to be applied to the device via the liquid nitrogen.

There is also disclosed a system for removing undesirable materials bonded to surfaces of devices, including: a vessel containing liquid nitrogen; a device having a surface with an undesirable material bonded thereto; a device holding member adapted and configured to hold the device; and a sonicating member at least partially extending into the liquid nitrogen and being adapted and configured to impart ultrasonic waves to the device via the liquid nitrogen.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a perspective view of a system for debonding an undesirable material from a surface of a device.

FIG. 2 is a perspective view of an embodiment of the system including a cooling member and source of liquid nitrogen.

FIG. 3 is a perspective view of an embodiment of the system including a variation of the device hanging member.

FIG. 4 is a perspective view of an embodiment of the system including another variation of the device hanging member.

FIG. 5 is a schematic view of an embodiment of the system including a subcooler.

FIG. 6 is a top schematic view of an embodiment of the system including shot blasting.

FIG. 7 is an elevation schematic view of the embodiment of the system including shot blasting.

### DESCRIPTION OF PREFERRED EMBODIMENTS

One of ordinary skill in the art will recognize that ultrasound energy is sound energy at a frequency above the human hearing range, i.e., above 20 kHz.

Performance of the method of the invention allows an undesirable material bonded to a surface of a device to be at least partially debonded from the device surface. Non-limiting examples of the material include deposits, coatings or laminates. Non-limiting examples of the devices include auto and household parts. Debonded means that the undesirable material is no longer bonded to the surface. However it is not necessarily completely removed in all cases from the vicinity of the surface. One example of this is when the method is performed with a device comprising a transmission filter. The filter includes a metal part having an elastomer bonded to at least a portion of the metal part's surface. In some instances, treatment according to the method might not completely remove the elastomer from the metal part. Such a debonded elastomer may have several cracks on its surface similar to what one sometimes sees in dried mud in an arid climate, i.e., a cracked mud flat.

In the case where the undesirable material is debonded but a portion of the debonded material still surrounds at least a portion of the surface, additional treatment may be undertaken to completely separate the undesirable material from the surface. One example is shot blasting where solid pellets or small metal balls are blasted on to the bonded surface. Here, the impact energy separates the loosely debonded material from the base allowing maximum removal of the undesirable material.

Non-limiting examples of devices suitable for treatment by the method include automotive parts having a resin or elastomer coated thereupon, such as a transmission filter, and metal paint hangers that are used to hang metal parts when the parts are being painted. Particular surgical instruments are those made of stainless steel. Non-limiting examples of undesirable materials include coatings, deposits, or laminates, such as paints, thermoplastics, thermosets, and elastomers.

The undesirable material is at least partially debonded from the surface of the device in the following manner. The device is at least partially immersed in liquid nitrogen. The low temperature of the liquid nitrogen tends to render the undesirable material brittle. A sonicating member applies ultrasonic wave energy to the either the liquid nitrogen which in turn transmits the ultrasonic wave energy to the surface. Alternatively, it may impart ultrasonic wave energy directly to the device or indirectly to the device via a device holding member or the vessel and holding member. The holding member is meant to be inclusive of devices that hold or suspend the device to be debonded from undesirable material thereupon. The ultrasonic waves create tiny bubbles of gaseous nitrogen adjacent the material on the device. When these bubbles collapse, significant energy is released. This tends to cause the brittle material to debond from the surface.

The ultrasonic liquid nitrogen treatment is preferably performed under ambient pressure.

In one embodiment, the liquid nitrogen may be subcooled. The advantage of using subcooled liquid nitrogen is that it can receive a significant amount of heat before it starts to boil. When selected, subcooled nitrogen may be maintained at any combination of pressure and temperature in the subcooled region for nitrogen that is achievable using any subcooling technology available at the time it is performed. Preferably, the subcooled nitrogen is at a pressure in the range of 4 bar to 14 bar and at a temperature in the range of −164° C. to −185° C. or −196° C. to −173° C.

Returning to the general description of the disclosed methods and systems, the temperature of the liquid nitrogen in the vessel may be maintained within a desired range by use of refrigeration or by heat exchange with a suitable low temperature heat exchange fluid such as subcooled liquid nitrogen.

Suitable sonicating members include a Telsonic Tube Resonator. The sonicating member may be operated at any frequency above sonic. A preferred frequency is greater than 20 kHz to about 150 kHz. Further refinements of this frequency range are from greater than 20 kHz to about 50 kHz and from greater than 50 kHz to about 100 kHz. A suitable treatment time depends upon the type and composition of the device and the undesirable material to be debonded. One of ordinary skill in the art will understand that routine experimentation by varying the above parameters may be performed in order to optimize the operating conditions.

Practice of the invention yields several advantages over the prior art. Shot blasting is not always required to separate the brittle parts from the metal surface. The device is not treated with any hazardous chemicals. In the case of metal paint hangers, the only waste material remaining in the system after treatment is the paint debonded from the metal surface. Because nitrogen is inert, no reaction product is produced. Finally, the only utility requirement is electricity.

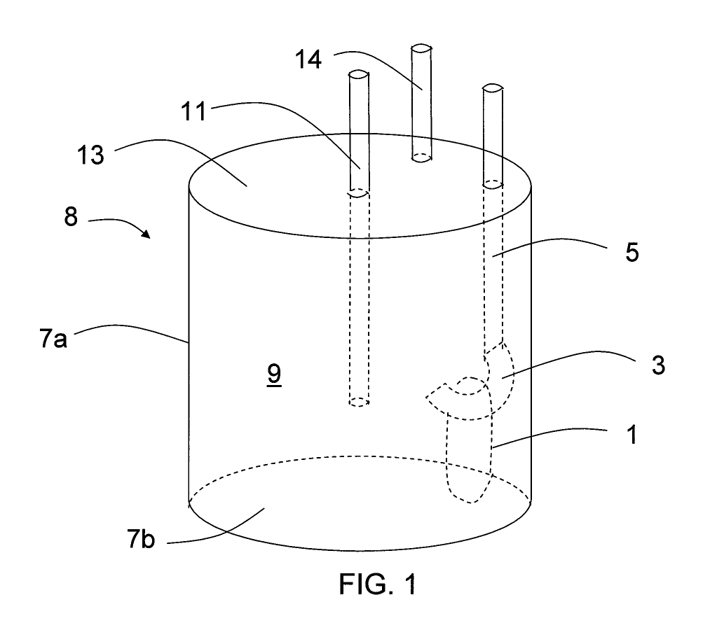

As best illustrated in FIG. 1, a system includes a securing element 3 depending from a leg element 5. The device 1 having the undesirable material debonded thereto is retained upon the securing element 3. The device 1 may be rigidly secured or loosely held (alternatively, the device may rest upon a bottom 7b of vessel 8). Together, the securing element 3 and leg element 5 comprise a device holding member. The device holding member and device 1 are positioned such that device 1 is immersed within liquid nitrogen 9 in vessel 8. Sonicating member 11 extends at least partially within liquid nitrogen 9. An upper surface of the liquid nitrogen is not depicted, but it is understood that at least a portion of the sonicating member 11 is immersed therein. The vessel 8 includes a bottom 7b from which vertical wall 7a extends.

The system includes an optional lid 13 having a vent 14 operable into closed or open positions. The optional lid 13 extends horizontally to upper ends of the vertically extending wall 7a. The optional lid 13 rests upon a shelf (not depicted) projecting inwardly from an upper end of an inner surface of vertically extending wall 7a. The optional lid 13 has a lid perimeter sized to conform to a vessel perimeter defined by a horizontal cross-section of the wall 7a above the shelf. The combination of the shelf and perimeter size allows the optional lid 13 to be securely placed over the vessel 8. The optional lid 13 has an aperture allowing the sonicating member 11 to extend therethrough and into the liquid nitrogen 9. The vent 14 allows undesirable levels of built-up pressure from vaporization of the liquid nitrogen 9 to be released from the vessel 8.

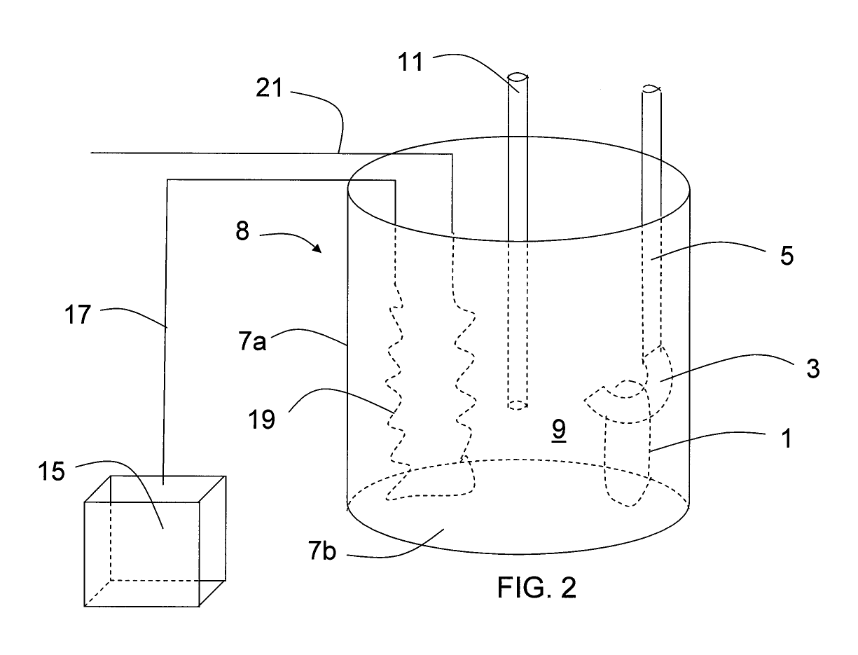

It should be noted that in each of FIGS. 1 and 2, the wall 7a of the vessel 8 is depicted as transparent in order to more clearly show the inside of vessel 8. It should be noted that the vessel need not be transparent.

While a cylindrically-shaped vessel 8 is depicted, it is understood that the vessel 8 may have any shape that allows containment of the liquid nitrogen 9, a non-limiting example of which includes a cube having the same or different dimensions of length, height, and width. In the case of a cube, it is then understood that such a vessel 8 would have four vertically extending walls. Also, while the securing element 3 is depicted as a semicircle, it is not limited to this shape. Rather, it may have any shape well known to those skilled in the art for holding devices that are to be dipped into a liquid. This includes holding the device, hanging the device, suspending the device, or securing the device, as the device is dipped into a liquid.

The sonicating member 11 need not project upwardly from the vessel 8. Indeed, it may have a height extending to, or below, a top of the vessel 8. It also need not project out from liquid nitrogen 9. Furthermore, it need not extend vertically. Rather, it may extend into the liquid nitrogen 9 horizontally or at an angle. The sonicating member 11 may be built into, suspended from, or supported by, the vertically extending wall 7a, bottom 7b, or any other structure outside the vessel 8.

It is also understood that the edge of the optional lid 13 need not rest upon a shelf or have a lid perimeter sized to conform to the vessel perimeter. Rather, all or a portion of the optional lid 13 may extend over or beyond upper ends of the vertically extending wall 7a. Generally speaking, the optional lid 13 should have a design that prevents vaporization of the liquid nitrogen 9.

As best depicted in FIG. 2, another embodiment of the system according to the invention is also similar to that of FIG. 1, but it also includes a source of liquid nitrogen 15 in fluid communication with a cooling member. The cooling member includes an inlet 17 which receives liquid nitrogen from the source of liquid nitrogen 15 and which is in fluid communication with coil portion 19. The coil portion 19 is in fluid communication with an outlet 21 for venting nitrogen from the system. Alternatively, the outlet 21 returns to the source 15 where the liquid nitrogen contained therein is chilled and returned to coil portion 19 via inlet 17. The cooling member allows the liquid nitrogen 9 to be maintained in the desired temperature range.

While a cylindrically-shaped vessel 8 is depicted, it is understood that the vessel 8 may have any shape that allows containment of the liquid nitrogen 9, a non-limiting example of which includes a cube having the same or different dimensions of length, height, and width. In the case of a cube, it is then understood that such a vessel 8 would have four vertically extending walls. Also, while the securing element 3 is depicted as a semicircle, it is not limited to this shape. Rather, it may have any shape well known to those skilled in the art for holding devices that are to be dipped into a liquid. This includes holding the device, hanging the device, suspending the device, or securing the device, as the device is dipped into a liquid.

The sonicating member 11 need not project upwardly from the vessel 8. Indeed, it may have a height extending to, or below, a top of the vessel 8. It also need not project out from liquid nitrogen 9. Furthermore, it need not extend vertically. Rather, it may extend into the liquid nitrogen 9 horizontally or at an angle. The sonicating member 11 may be built into, suspended from, or supported by, the vertically extending wall 7a, bottom 7b, or any other structure outside the vessel 8.

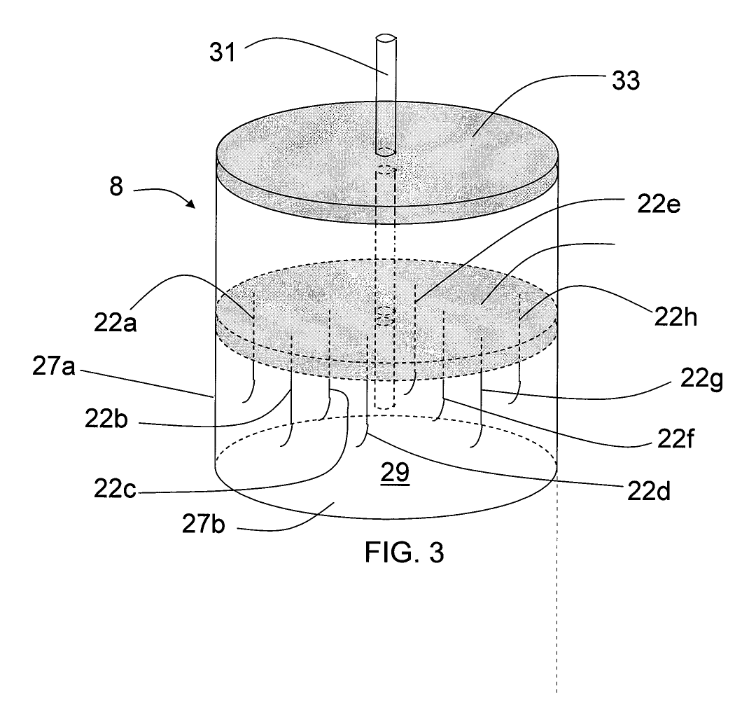

As best illustrated in FIG. 3, another embodiment of the system according to the invention is also similar to that of FIG. 1, but it includes a variation of the device holding member. It should be noted that wall 27a of the vessel 8 is depicted as transparent in order to more clearly show the inside of vessel 8.

The optional lid 33 has an aperture allowing the sonicating member 31 to be inserted therethrough. The optional lid 33 extends horizontally to upper ends of the vertically extending wall 27a. The optional lid 33 rests upon a shelf (not depicted) projecting inwardly from an upper inner surface of vertically extending wall 27a. The optional lid 33 also has a lid perimeter sized to conform to a vessel perimeter defined by inner surfaces of a horizontal cross-section of the wall 27a above the shelf. The combination of the shelf and perimeter size allows the optional lid 33 to be securely placed over the vessel 8. One of ordinary skill in the art will recognize that the shape and size of the various parts of the vessel 8 and the wavelength of the ultrasound energy applied to the device 1 may be designed such that optimal reflection of ultrasound waves from the vessel 8 to the device 1 is achieved thereby maximizing energy density at the surface of the device 1.

In this embodiment, the device holding member includes a horizontally extending element 4 from which hooks 22a-h extend downwardly. The horizontally extending element 4 includes an aperture allowing the sonicating member 31 to be inserted through. Similar to the optional lid 33, the horizontally extending element 4 has a horizontally extending element perimeter sized to conform to a vessel perimeter defined by inner surfaces of a horizontal cross-section of the wall 27a. Also similar to the optional lid 33, the horizontally extending element may rest upon a shelf projecting from an inner surface of the wall 27a. The number of hooks 22a-h need not be eight. Rather, the number may be increased to accommodate more devices to be treated or decreased to allow a larger ratio of liquid nitrogen 29 volume per unit device surface area or to accommodate larger-sized devices.

For clarity's sake no devices are depicted as hanging from the hooks 22a-h. Furthermore, while a cylindrically-shaped vessel 8 is depicted, it is understood that the vessel 8 may have any shape allowing containment of the liquid nitrogen 29, a non-limiting example of which includes a cube having the same or different dimensions of length, height, and width. In the case of a cube, it is then understood that such a vessel 8 would have four vertically extending walls. The hooks 22a-h are not limited to the shape depicted. Rather, it may have any shape well known to those skilled in the art for hanging devices to be dipped into a liquid. Finally, the sonicating member 11 need not project upwardly from the vessel 8. Indeed, it may have a height extending to, or below, a top of the vessel 8. It also need not project out from liquid nitrogen 9. Furthermore, it need not extend vertically. Rather, it may extend into the liquid nitrogen 9 horizontally or at an angle. The sonicating member 11 may be built into, suspended from, or supported by, the vertically extending wall 7a, bottom 7b, or any other structure outside the vessel 8.

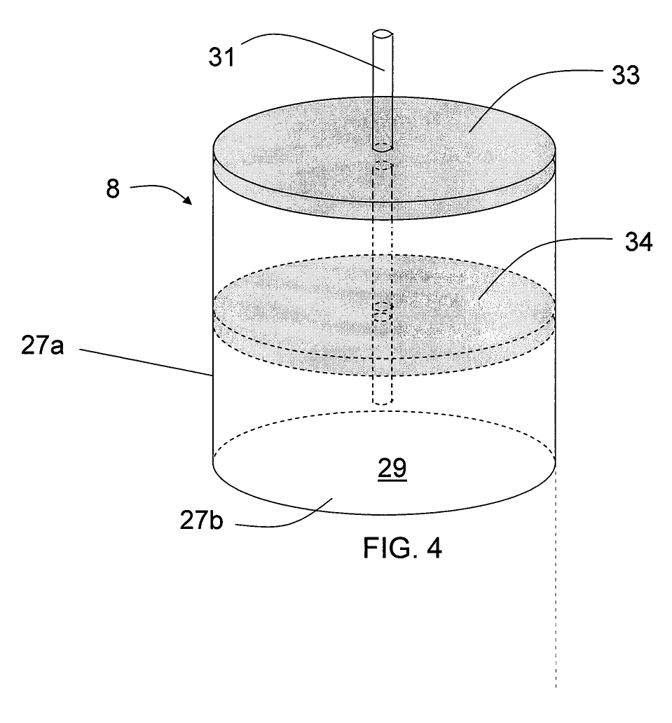

As best illustrated in FIG. 4, another embodiment of the system according to the invention is also similar to that of FIG. 3, but includes another variation of the device holding member. It should be noted that wall 27a of the vessel 8 is depicted as transparent in order to more clearly show the inside of vessel 8.

The optional lid 33 has an aperture allowing the sonicating member 31 to be inserted therethrough. The optional lid 33 extends horizontally to upper ends of the vertically extending wall 27a. The optional lid 33 rests upon a shelf (not depicted) projecting inwardly from an upper inner surface of vertically extending wall 27a. The optional lid 33 also has a lid perimeter sized to conform to a vessel perimeter defined by inner surfaces of a horizontal cross-section of the wall 27a above the shelf. The combination of the shelf and perimeter size allows the optional lid 33 to be securely placed over the vessel 8.

In this embodiment, the device holding member 34 extends horizontally to inner surfaces of the wall 27a while devices (not depicted) rest thereupon. Similar to the optional lid 33, the device holding member 34 extends to inner surfaces of the wall 27a and has a perimeter sized to conform to a vessel perimeter defined by inner surfaces of a horizontal cross-section of the wall 27a.

The device holding member 34 includes a plurality of apertures, one of which allows the sonicating member 31 to be inserted through. The additional apertures allow the device holding member 34 to allow liquid nitrogen 29 to be circulated therethrough for more uniform treatment of the surfaces to be cleaned from the devices. After the high pressure in the vessel 8 is lowered to atmospheric, the apertures further allow the now liquid nitrogen to be drained from the device holding member 34 as such member 34 is raised out of the vessel 8.

While a cylindrically-shaped vessel 8 is depicted, it is understood that the vessel 8 may have any shape allowing containment of the liquid nitrogen 29, a non-limiting example of which includes a cube having the same or different dimensions of height, length and width. In the case of a cube, it is then understood that such a vessel 8 would have four vertically extending walls. Also, the sonicating member 11 need not project upwardly from the vessel 8. Indeed, it may have a height extending to, or below, a top of the vessel 8. It also need not project out from liquid nitrogen 9. Furthermore, it need not extend vertically. Rather, it may extend into the liquid nitrogen 9 horizontally or at an angle. The sonicating member 11 may be built into, suspended from, or supported by, the vertically extending wall 7a, bottom 7b, or any other structure outside the vessel 8.

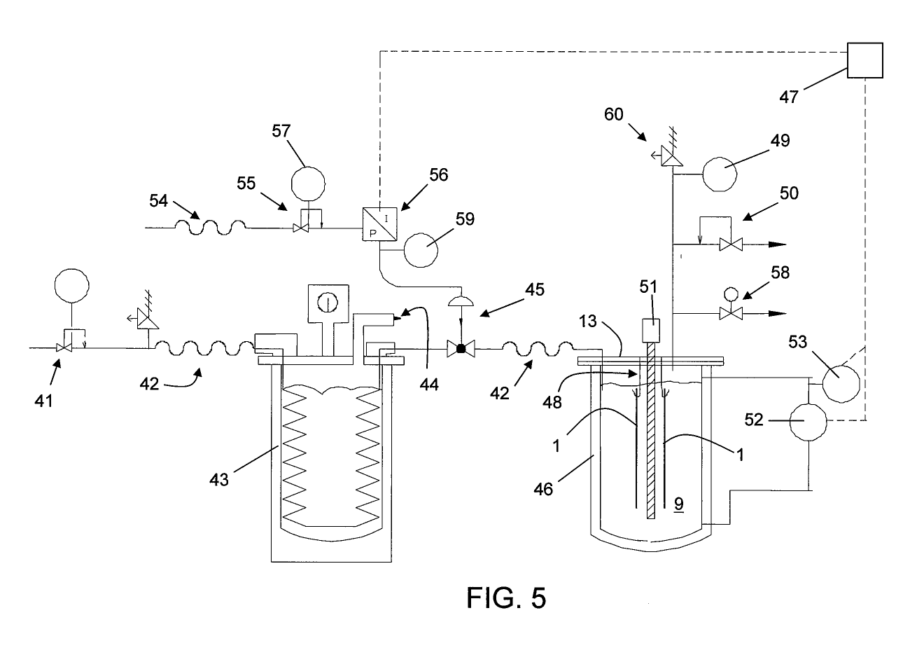

Another embodiment is best shown in FIG. 5. High pressure liquid nitrogen is provided. Typically, it is at a pressure in the range of from 6.8 to 17.2 bar and at a temperature in the range of from −173 to −195° C. Preferably, it is at a pressure in a range of 13-14 bar and at a temperature in range of −184 to −195° C. It flows through pressure regulator 41, tubing 42, and into subcooler 43. The subcooler 43 drops the temperature of the high pressure liquid nitrogen to place it in the subcooled state so any energy put into the system which is transformed into heat will delay boiling of the working fluid. Vent 44 allows overpressure in the subcooler 43 to be released.

A flow of subcooled liquid nitrogen then flows through tubing 42 and into vessel 46. Sonicating member 51 extends into the subcooled liquid nitrogen 9 through optional lid 13. Devices 1 are suspended within the subcooled liquid nitrogen 9 with device holding members 48. Alternatively, the devices 1 may be secured to a holder, rest upon a tray, or rest upon a bottom surface of vessel 46 or in any other manner disclosed above. Ultrasound energy is imparted to the subcooled liquid nitrogen 9 by sonicating member 51. The ultrasonic waves create tiny bubbles of gaseous nitrogen on the surface of the devices 1. When these bubbles collapse, significant energy is released tending to cause brittle material on the metal surface to detach from the surface. Subcooled liquid nitrogen is maintained in a vacuum insulated vessel 46, the advantages of which include noise isolation and reduction of heat leaks from ambient into the subcooled liquid nitrogen. Alternatively, the vessel 46 may utilize foam insulation instead of vacuum insulation. By maintaining the liquid nitrogen in the subcooled condition, addition of heat by the ultrasound energy will not readily result in boiling of the liquid nitrogen.

The level of subcooled liquid nitrogen in vessel 46 is monitored with pressure gauge/transducer 52/53. Based upon the signal from transducer 53, controller 47 sends a signal to the current-to-pressure transducer 56. The transducer 56 controls the pressure of instrument gas flowing through flex hose 54 past instrument gas regulator/pressure gauge 55/57. Pressure gauge 59 is utilized to verify that the instrument gas has been adjusted to the appropriate level by transducer 56. Using this combination of equipment, the sensed liquid level in vessel 46 is used to increase or decrease the flow of high pressure liquid nitrogen in a known manner by way of the control valve 45 that is actuated by instrument air. Alternatively, the control valve 45 may be an electrically actuated valve. In such a case, flex instrument air, hose 54, regulator/pressure gauge 55/57, transducer 56, and gauge 59 are eliminated.

A desired pressure (displayed by pressure gauge 49) within vessel 46 may be maintained by manipulating back pressure regulator 50. Excess gaseous nitrogen may be vented via valve 58. In case the back pressure regulator 50 fails, an over-pressure condition is alleviated by relief valve 60.

One of ordinary skill in the art will recognize that the method and/or system may be either batch or continuous.

Optionally, application of mechanical energy, such as shot blasting, may be performed after treatment with ultrasound energy and liquid (optionally subcooled) nitrogen. Application of ultrasound energy might not completely separate all of the undesirable material from the device. In that case, the material might be debonded from the device, but not completely removed from the vicinity of the device surface. In that case, shot blasting may be used to completely separate the debonded material from the device.

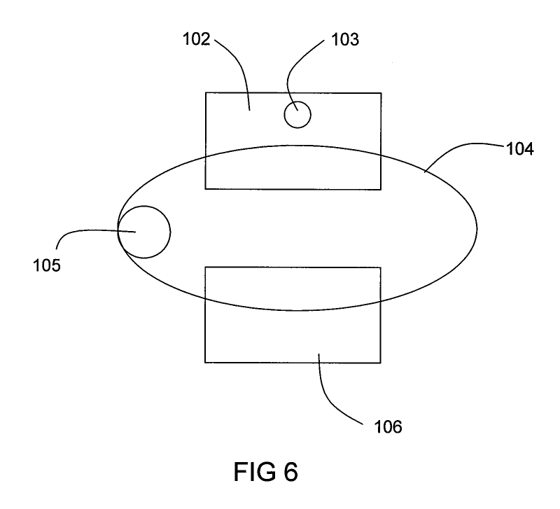

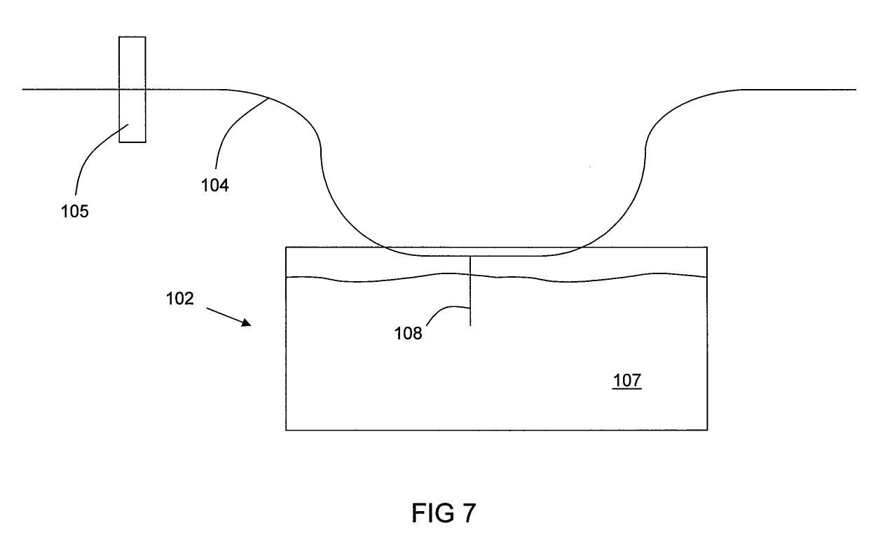

A combination of the ultrasonic liquid nitrogen treatment method with shotblasting is shown in FIGS. 6 and 7. Devices 108 are conveyed by a conveyor 104 via motor 105 to vessel 102. Vessel 102 contains liquid nitrogen 107. Ultrasonic energy is produced by sonicator 103. Devices 108 thus treated are continuously or discontinuously conveyed to shot blasting device 106 where shot blasting more completely removes the debonded material. Shot blasting device 106 provides the mechanical agitation to remove the debonded material from the device. Off the shelf shot blasting systems from such companies as Wheelabrator provide the mechanical energy via a rotating disc with radial blades that hurl shot of desired size into the target (which is the material to be debonded). This mechanical action fractures the material and removes it from the substrate. Typically a separation process recycles the shot for reuse.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

What is claimed is:

1. A method of debonding an undesirable material from a device, comprising the steps of: providing a vessel containing liquid nitrogen; providing a device having a surface with an undesirable material bonded thereto; immersing at least a portion of the bonded material and surface in the liquid nitrogen within the vessel; and causing ultrasonic wave energy to be applied to the device via the liquid nitrogen.

2. The method of claim 1, wherein the device is a metal hanger adapted and configured to hold metal parts during painting of the metal parts, the metal hanger has a paint residue thereupon, and performance of said step of applying is performed for a period of time sufficient to debond at least some of the paint residue.

3. The method of claim 2, further comprising the step of blasting shot at the debonded metal part thereby fully separating the debonded paint from the metal part.

4. The method of claim 1, wherein said step of providing a vessel containing liquid nitrogen comprises the steps of passing high pressure liquid nitrogen through a subcooler where it is subcooled and allowing the subcooled liquid nitrogen to flow into the vessel.

5. The method of claim 1, wherein the ultrasonic waves have a frequency of greater than 20 kHz to about 50 kHz.

6. The method of claim 1, wherein the ultrasonic waves have a frequency of about 50 kHz to about 100 kHz.

7. The method of claim 4, wherein a temperature of the subcooled liquid nitrogen is in a range of from about −196° C. to about −173° C.

8. The method of claim 4, wherein a pressure of the subcooled liquid nitrogen is in a range of from about 4 bar to about 14 bar.

9. The method of claim 1, wherein the device is an automotive part having an elastomer bonded thereto and performance of said step of applying is performed for a period of time sufficient to debond at least some of the elastomer from the automotive part

10. The method of claim 9, further comprising the step of blasting shot at the debonded metal part thereby fully separating the debonded paint from the metal part.

11. The method of claim 10, wherein the part from which at least some of the elastomer has been debonded is conveyed via a conveyor to where the part is shot blasted.

12. The method of claim 11, wherein the conveyor is continuous and extends from a location where said step of applying is performed to a location where said step of blasting shot is performed back to the location where said step of applying is performed.

13. The method of claim 1, wherein said steps are performed under ambient pressure.

14. The method of claim 1, wherein the device is totally immersed in the liquid nitrogen.

15. A system for removing undesirable materials bonded to surfaces of devices, comprising:
a) a vessel containing liquid nitrogen;
b) a device having a surface with an undesirable material bonded thereto;
c) a device holding member adapted and configured to hold said device;
d) a sonicating member at least partially extending into said liquid nitrogen and being adapted and configured to impart ultrasonic waves to said device via said liquid nitrogen.

16. The system of claim 15, further comprising:
a) a source of non-subcooled liquid nitrogen; and
b) a subcooler in fluid communication with said source of non-subcooled liquid nitrogen and said vessel.

17. The system of claim 15, wherein said device holding member comprises a metal hanger adapted and configured to hang metal parts during painting and said undesirable material comprises paint.

18. The system of claim 15, wherein said device comprises an automotive part and the undesirable material comprises an elastomer material.

19. The system of claim 18, further comprising:
a shot blasting device adapted and configured to blast shot at the automotive part with enough force to remove at least part of the debonded elastomer from the part; and
a conveyor extending from said vessel to said shot blasting device and back to said vessel, said conveyor being adapted and configured to conveyor the part from the vessel to the shot blasting device.

20. The system of claim 15, wherein said liquid nitrogen is open to the atmosphere.

21. The system of claim 15, wherein the device is totally immersed in the liquid nitrogen.

22. A method debonding an undesirable material from a device, comprising the steps of: immersing a device into liquid nitrogen and causing ultrasonic wave energy to be applied to the device while the device is immersed, wherein the device has a surface with an undesirable material bonded thereto.
